(19) United States
(12) Patent Application Publication
(10) Pub. No.: US 2020/0137252 A1
(43) Pub. Date: Apr. 30, 2020

(54) INFORMATION PROCESSING APPARATUS, CONTROL SYSTEM, AND IMAGE FORMING APPARATUS THAT CHANGE STATE OF IMAGE FORMING APPARATUS IN ACCORDANCE WITH NUMBER OF PERSONS PRESENT IN AREA WHERE IMAGE FORMING APPARATUS IS INSTALLED

(71) Applicant: KYOCERA Document Solutions Inc., Osaka (JP)

(72) Inventor: Minoru WADA, Osaka (JP)

(73) Assignee: KYOCERA Document Solutions Inc., Osaka (JP)

(21) Appl. No.: 16/659,773

(22) Filed: Oct. 22, 2019

(30) Foreign Application Priority Data
Oct. 26, 2018 (JP) 2018-202280

(51) Int. Cl. H04N 1/00

(52) U.S. Cl. CPC H04N 1/00896; H04N 2201/0094; H04N 1/0097; H04N 1/00326

(57) ABSTRACT

An information processing apparatus includes: a storage device that stores installation area information indicating an area where an image forming apparatus is installed; a communication device; and a control device. The control device functions as a controller that, in accordance with the number of persons present per area obtainable based on detection information acquired by an entry and exit detecting device, determines, per area indicated by the installation area information, a state of the image forming apparatus installed in each area, and transmits a command notice for changing the state of the image forming apparatus into the determined state, via the communication device, to the image forming apparatus installed in each of the areas. The controller transmits the command notice for changing the state of the image forming apparatus into a predetermined state where power consumption is more reduced, as the number of persons present in the area decreases.

### INCORPORATION BY REFERENCE

This application claims priority to Japanese Patent Application No.2018-202280 filed on 26 Oct. 2018, the entire contents of which are incorporated by reference herein.

### BACKGROUND

The present disclosure relates to an information processing apparatus, a control system, and an image forming apparatus, particularly to a technique for reducing power consumption of the image forming apparatus.

Technologies to reduce the power consumption of image forming apparatuses such as multifunction peripherals have been proposed. For example, there is a known first technique including a detection unit that detects movement of a person and controls a state of the image forming apparatus by the movement of the person. In addition, there is a known second technique in which the number of information processing apparatuses connected to the image forming apparatus is detected and the state of the image forming apparatus is controlled according to the detected number.

In addition, there is a known third technique in which the number of persons entering and exiting an area is detected by the imaging device, and the state of the image forming apparatus is controlled by the number of persons in the area. There is also a known fourth technique that controls the state of the image forming apparatus based on attendance information and usage frequency information of the attendance management device.

### SUMMARY

A technique improved over the aforementioned technique is proposed as one aspect of the present disclosure.

An information processing apparatus according to one aspect of the present disclosure is the information processing apparatus that manages an image forming apparatus installed in a building having a plurality of areas, and includes a storage device, a communication device, and a control device. The storage device stores installation area information indicating an area where the image forming apparatus is installed, of the plurality of areas. The communication device makes communication with an external apparatus. The control device includes a processor and functions as a controller when the processor executes a control program. In accordance with the number of persons present per area obtainable based on detection information acquired by an entry and exit detecting device provided per area and detecting entering and exiting of the respective areas, the controller determines, per area indicated by the installation area information, a state of the image forming apparatus installed in each area, and transmits a command notice for changing the state of the image forming apparatus into the determined state, via the communication device, to the image forming apparatus installed in each of the areas. The controller transmits the command notice for changing the state of the image forming apparatus into a predetermined state where power consumption is more reduced, as the number of persons present in the area decreases.

A control system according to another aspect of the present disclosure includes an entry and exit detecting device, an information processing apparatus, and a plurality of image forming apparatuses. The entry and exit detecting device detects entering and exiting per area, in a building having a plurality of areas. The information processing apparatus includes a storage device, a communication device, and a control device. The storage device stores installation area information indicating an area where an image forming apparatus is installed, of the plurality of areas. The communication device makes communication with an external apparatus. The control device includes a processor and functions as a controller when the processor executes a control program. In accordance with the number of persons present per area obtainable based on detection information acquired by the entry and exit detecting device, the controller determines, per area indicated by the installation area information, a state of the image forming apparatus installed in each area, and transmits a command notice for changing the state of the image forming apparatus into the determined state, via the communication device, to the image forming apparatus installed in each of the areas. The controller transmits the command notice for changing the state of the image forming apparatus into a predetermined state where power consumption is more reduced, as the number of persons present in the area decreases. The image forming apparatus includes an image forming apparatus side controller and an image forming device. The image forming apparatus side controller changes the state of the image forming apparatus in accordance with the command notice transmitted from the information processing apparatus. The image forming device forms an image on a recording medium.

An image forming apparatus according to another aspect of the present disclosure is the image forming apparatus that is installed in a building having a plurality of areas, and includes an image forming device and a control device. The image forming device forms an image on a recording medium. The control device includes a processor and functions as a controller when the processor executes a control program. In accordance with the number of persons present in an area, of the plurality of areas, obtainable based on detection information acquired by an entry and exit detecting device detecting entering and exiting of the area where the image forming apparatus is installed, the controller changes a state of the image forming apparatus into a predetermined state where power consumption is more reduced, as the number of persons present in the area decreases.

An image forming apparatus according to another aspect of the present disclosure includes a storage device, a communication device, a control device, and an image forming device. The storage device stores installation area information indicating each area where the image forming apparatus is installed and each area where other image forming apparatus is installed, respectively. The communication device makes communication with an external apparatus. The control device includes a processor and functions as a controller when the processor executes a control program. In accordance with the number of persons present per area obtainable based on detection information acquired by an entry and exit detecting device provided per area and detecting entering and exiting of the respective areas, the controller changes, per area indicated by the installation area information, a state of the image forming apparatus and a state of other image forming apparatus that are installed in the respective areas. The controller determines the state of the image forming apparatus to be a preset first state where power consumption is more reduced, as the number of persons present in the area decreases, determines the state of other image forming apparatus to be a preset second state where power consumption is more reduced, as the number of persons present in the area decreases, and on a basis of the installation area information stored in the storage device, the controller changes the state of the image forming apparatus into the first state determined, and transmits a command notice for changing the state of the other image forming apparatus into the second state determined, via the communication device, to the other image forming apparatus. The image forming device forms an image on a recording medium,

### BRIEF DESCRIPTION OF THE DRAWINGS

FIG. 1 is a diagram showing an entire configuration of a control system containing an information processing apparatus according to a first embodiment of the present disclosure.

FIG. 2 is a schematic side view of a building, in which apparatuses constituting the control system are located.

FIG. 3 is a functional block diagram schematically showing an essential internal configuration of an image forming apparatus constituting the control system.

FIG. 4 is a functional block diagram schematically showing an essential internal configuration of an information processing apparatus according to a first embodiment.

FIG. 5 is a diagram showing an example of data structure stored in authentication data storage.

FIG. 6 is a diagram showing an example of data structure stored in staying location information storage.

FIG. 7 is a diagram showing an example of data structure stored in installation area information storage.

FIG. 8 is a flowchart showing an example of processing performed by a control device of the information processing apparatus according to the first embodiment.

FIG. 9 is a flowchart showing another example of processing performed by the control device of the information processing apparatus according to the first embodiment.

FIG. 10A to FIG. 10D are diagrams each showing a flag to be used to identify an installation area of the image forming apparatus.

FIG. 11 is a functional block diagram schematically showing an essential internal configuration of the information processing apparatus according to a third embodiment.

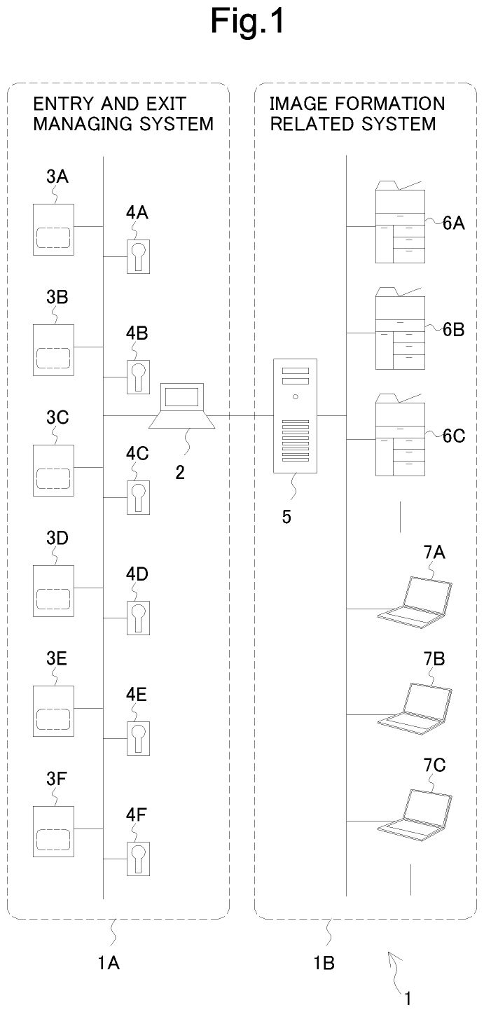

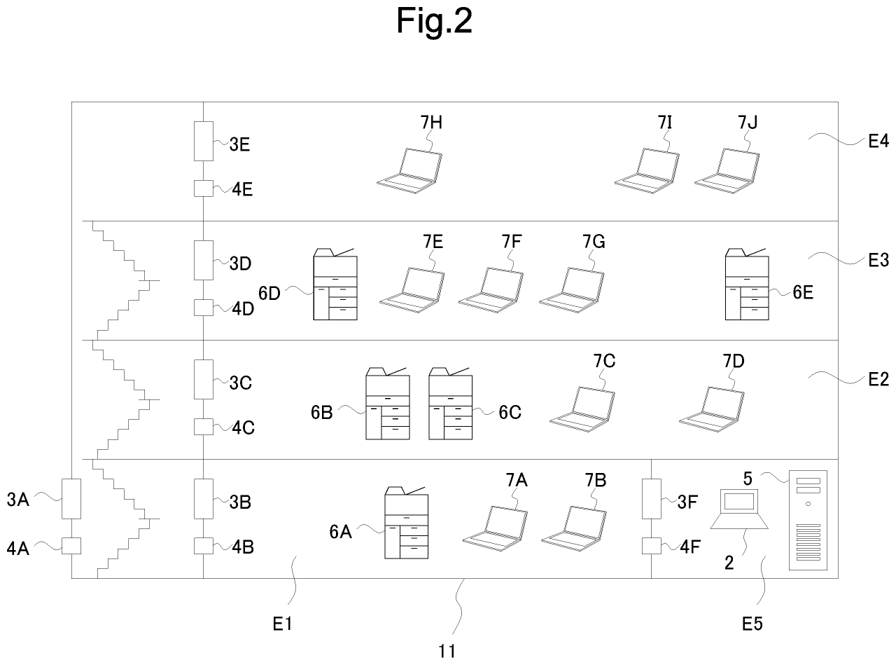

Hereafter, an information processing apparatus, a control system, and an image forming apparatus according to an embodiment of the present disclosure will be described, with reference to the drawings. FIG. 1 is a diagram showing an entire configuration of the control system containing the information processing apparatus according to the first embodiment of the present disclosure. FIG. 2 is a schematic side view of a building, in which apparatuses containing the control system are located.

The control system 1 includes an information processing apparatus 2, card readers 3A to 3F (hereinafter, collectively “card reader 3” as the case may be), electric locks 4A to 4F (hereinafter, collectively “electric lock 4” as the case may be), a server 5, image forming apparatuses 6A to 6E (hereinafter, collectively “image forming apparatus 6” as the case may be), terminal apparatuses 7A to 7J (hereinafter, collectively “terminal apparatus 7” as the case may be).

The image forming apparatus 6A and the terminal apparatuses 7A and 7B are installed in an area E1 on the first floor of a building 11; the image forming apparatuses 6B and 6C and the terminal apparatuses 7C and 7D are installed in an area E2 on the second floor; the image forming apparatuses 6D and 6E and the terminal apparatuses 7E to 7G are installed in an area E3 on the third floor; and the terminal apparatuses 7H to 7J are installed in an area E4 on the fourth floor. In an area E5 on the first floor, where a management room is located, the information processing apparatus 2 and the server 5 are installed.

The card reader 3 and the electric lock 4 are connected to the information processing apparatus 2, via a network such as a local area network (LAN). The information processing apparatus 2, the card reader 3, and the electric lock 4 constitute an entry and exit managing system 1A. The information processing apparatus 2 may be, for example, a personal computer (PC).

The card reader 3A is disposed in a doorway of the building 11 and detects entering and exiting of the building 11. The card readers 3B to 3F are each disposed in the doorway corresponding to each of the areas E1 to E5 in the building 11, and detect entry and exit of persons with respect to each of the areas E1 to E5. The electric lock 4A is disposed at an entrance/exit door of the building 11. The electric locks 4B to 4F are each disposed at the entrance/exit door corresponding to each of the areas E1 to E5.

A user can release the electric lock 4 by holding over the card reader 3 a non-contact IC card that he or she is carrying. For example, when the user holds the IC card over the card reader 3, the card reader 3 reads an ID number (such as an employee number) written in the IC card, and transmits the read ID number to the information processing apparatus 2. The card reader 3 detects entering and exiting of the area and is also used for personal authentication. The card reader 3 is one example of the entry and exit detecting device recited in What is claimed is.

On the basis of the ID number received, the information processing apparatus 2 executes authentication processing, and upon determining that entry to the building 11 or entry to each of the areas E1 to E5 is permitted, releases the electric lock 4 disposed at the corresponding entrance/exit door. Detail descriptions of the processing just described will follow later on.

The server 5 is connected to the image forming apparatus 6 and the terminal apparatus 7 via a network such as LAN. The server 5 can exchange information with the image forming apparatus 6 and the terminal apparatus 7. The server 5, the image forming apparatus 6, and the terminal apparatus 7 constitute an image forming cooperative system 1B. The image forming apparatus 6 can be exemplified by a multifunction peripheral having a plurality of functions such as copying, printing, scanning, and facsimile transmission. The terminal apparatus 7 can be exemplified by a PC.

The server 5 serves to relay an operation instruction from the terminal apparatus 7 to the image forming apparatus 6 and also, receives apparatus state information being transmitted from the image forming apparatus 6 and indicating the state of the image forming apparatus 6 (e.g., power status, and type of job), to monitor and manage the state of the image forming apparatus 6.

The information processing apparatus 2 is connected to the server 5 to exchange information with the server 5. The information processing apparatus 2 also exchanges information with the image forming apparatus 6 via the server 5. For example, the information processing apparatus 2 receives the apparatus state information transmitted from the image forming apparatus 6, to monitor and manage the state of the image forming apparatus 6, like the server 5. The information processing apparatus 2 also transmits a command notice for changing the state of the image forming apparatus 6, via the server 5 to the image forming apparatus 6.

Upon receipt of the command notice transmitted from the information processing apparatus 2 via the server 5, the image forming apparatus 6 changes the state of the image forming apparatus 6 in accordance with the command notice received.

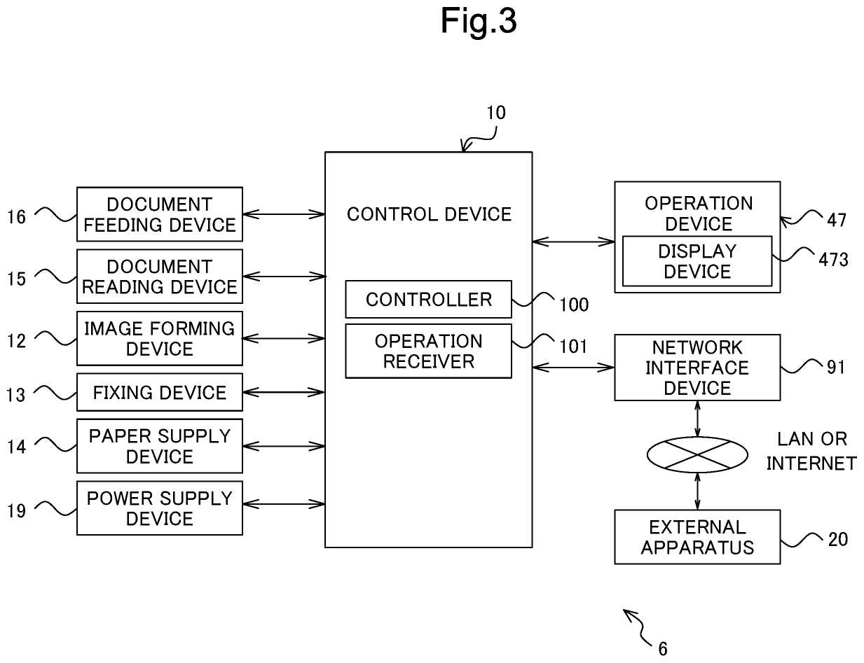

FIG. 3 is a functional block diagram schematically showing an essential internal configuration of the image forming apparatus 6 constituting the control system 1. The image forming apparatus 6 includes a control device 10, a document feeding device 16, a document reading device 15, an image forming device 12, a fixing device 13, a paper supply device 14, an operation device 47, a power supply device 19, and a network interface device 91.

In the image forming apparatus 6, document reading operation is performed as follows. The document reading device 15 optically reads an image on a source document delivered from the document feeding device 16 or placed on a contact glass, and generates image data. The image data generated by the document reading device 15 is stored, for example, in an image memory.

In the image forming apparatus 6, image forming operation is performed as follows. On the basis of the image data generated through the document reading operation or received from an external apparatus 20 connected to the network, such as a computer (e.g., server 5), the image forming device 12 forms a toner image on a recording sheet serving as a recording medium, and delivered from the paper supply device 14.

The fixing device 13 applies heat and pressure to the recording sheet, on which the toner image has been formed by the image forming device 12, thereby fixing the toner image onto the recording sheet. The recording sheet with the toner image fixed thereon is discharged to an output tray. The paper supply device 14 includes one or more paper feed cassettes.

The operation device 47 receives instructions from an operator, for operations and processing that the image forming apparatus 6 is configured to perform, such as the image forming operation. The operation device 47 includes a display device 473 for displaying a guidance and so forth to the operator.

The display device 473 has a touch panel function, so that the operator can operate the image forming apparatus 6 by touching a button or a key displayed on the screen of the display device 473.

The power supply device 19 includes a power circuit that controls the power to be supplied to each component of the image forming apparatus 6 for making the image forming apparatus 6 operate. The power supply device 19 follows instructions from a controller 100 and supplies or stops supplying the power to each component of the image forming apparatus 6. The image forming apparatus 6 becomes a power-off state when the power supply device 19 stops supplying the power to each component of the image forming apparatus 6.

The network interface device 91 serves to transmit and receive various types of data, to and from the external apparatus 20 in the local area or on the internet, such as the server 5, the terminal device 7, and the information processing apparatus 2.

The control device 10 includes a processor, a random-access memory (RAM), a read-only memory (ROM), and a single-purpose hardware circuit. The processor is, for example, a central processing unit (CPU), an application specific integrated circuit (ASIC), or a micro processing unit (MPU).

The control device 10 functions as the controller 100 and an operation receiver 101, by operating according to a control program stored in a hard disk drive (HDD). However, the controller 100 and the operation receiver 101 may each be constituted of a hardware circuit, instead of being realized by the operation of the control device 10 according to the control program. This also applies to other embodiments, unless otherwise specifically noted.

The controller 100 governs overall operation of the image forming apparatus 6. The control device 10 is connected to the document feeding device 16, the document reading device 15, the image forming device 12, the fixing device 13, the paper supply device 14, the operation device 47, and the network interface device 91. The controller 100 controls the operation of each of the mentioned components.

The controller 100 transmits the apparatus state information indicating the state of the image forming apparatus 6, to the server 5 via the network interface device 91. Examples of the apparatus state indicated by the apparatus state information are: a state where operation using the printing function, copying function, scanning function, or facsimile function is being performed; a state where operation using a USB memory is being performed; a state where the power is turned on; and a state where the power is turned off.

In receiving the command notice transmitted via the server 5 from the information processing apparatus 2, the controller 100 also controls the image forming apparatus 6 in accordance with the command notice received.

The operation receiver 101 receives inputs from the user made through the operation device 47. For example, the operation receiver 101 receives an operation of the user performed on hard keys provided on the operation device 47. The operation receiver 101 also receives operation of the user performed on the screen of the display device 473, by means of the touch panel function of the display device 473. The controller 100 controls the operation of the image forming apparatus 6 in accordance with the operation of the user received by the operation receiver 101.

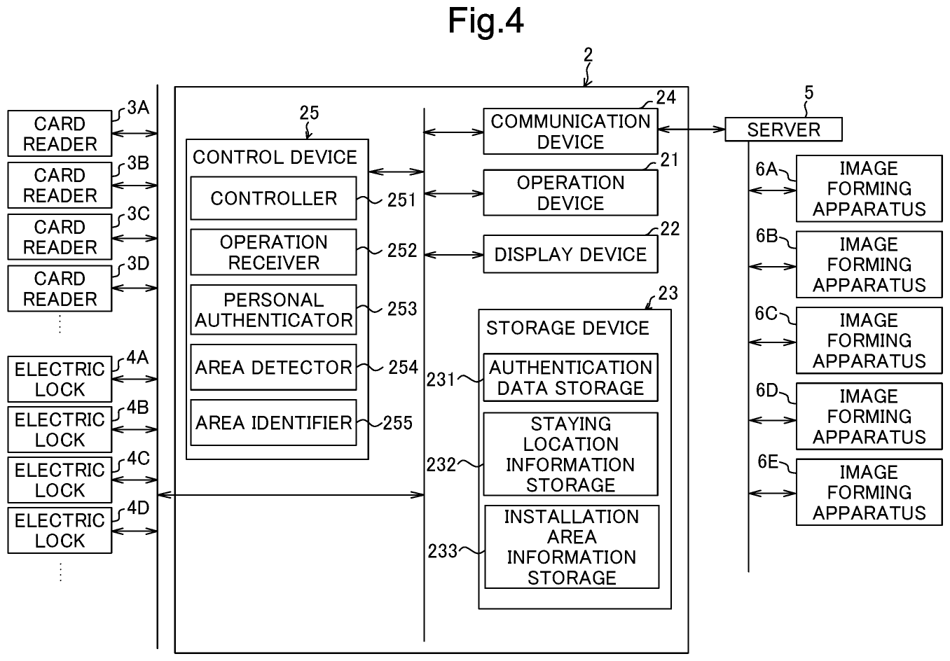

FIG. 4 is a functional block diagram schematically showing an essential internal configuration of the information processing apparatus according to the first embodiment. The information processing apparatus 2 includes an operation device 21, a display device 22, a storage device 23, a communication device 24, and a control device 25. These components can transmit and receive data or signals to and from each other, via a communication bus.

The operation device 21 includes a keyboard and a mouse. The operation device 21 inputs a command or characters to the control device 25 in response to operation by the user, and moves a pointer on a screen of the display device 22. The display device 22 displays a response from the control device 25 or a data result.

The storage device 23 is a storage medium such as a HDD containing programs and data necessary for operating the information processing apparatus 2. The storage device 23 functions as authentication data storage 231, the staying location information storage 232, and installation area information storage 233.

The authentication data storage 231 contains authentication data to be used for determining whether a person who wishes to enter the building 11 has entrance qualifications or not and authentication data to be used for determining whether a person who wishes to enter each of the areas E1 to E5 within the building 11 has entrance qualifications or not.

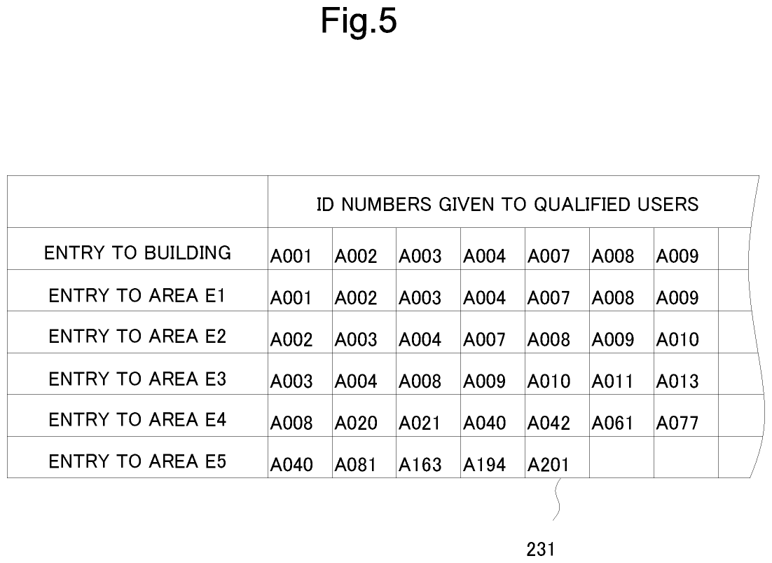

FIG. 5 is a diagram showing an example of data structure stored in the authentication data storage 231. As shown in FIG. 5, the authentication data storage 231 stores, in association with an item “entry to building”, ID numbers given to users who have entrance qualifications for entering the building 11. The authentication data storage 231 stores, in association with each item “entry to area E1” to “entry to area E5”, ID numbers given to users who have entrance qualifications for entering each of the area E1 to E5.

The staying location information storage 232 stores, in association with the ID numbers, staying location information indicating staying locations of the users given the ID numbers.

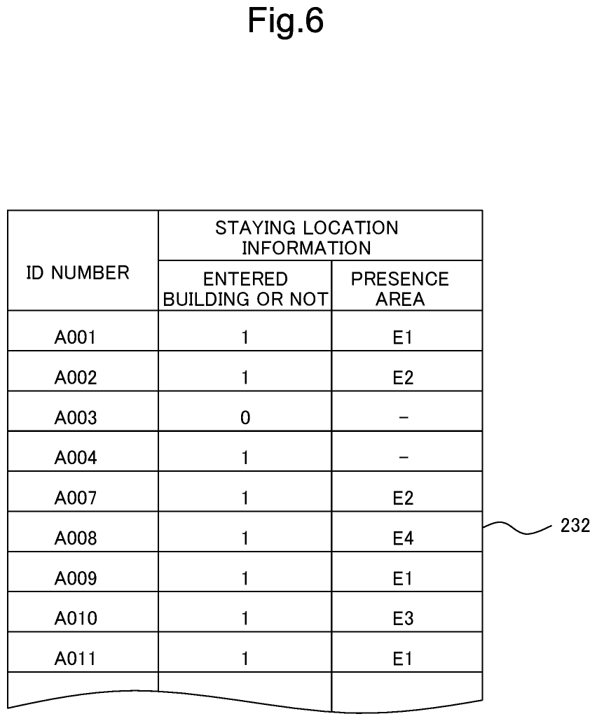

FIG. 6 is a diagram showing an example of data structure stored in the staying location information storage 232. As shown in FIG. 6, the staying location information storage 232 stores, in association with each of the ID numbers, the staying location information: the staying location information includes data on “entered building or not” and data on “presence area”. When the user has entered the building 11, the data on “entered building or not” shows “1”, and when the user has not entered the building 11, the data on “entered building or not” shows “0”. The data on “presence area” contains the area numbers where the user is present. For example, from the content stored in the staying location information storage 232, it is shown that the user who has given the ID number “A001” is present in the area E1.

The installation area information storage 233 stores the installation area information indicating the areas where the image forming apparatuses 6A to 6E are installed.

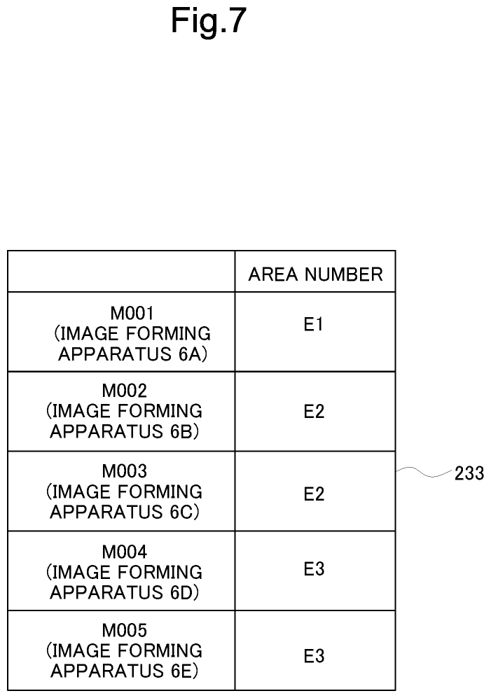

FIG. 7 is a diagram showing an example of data structure stored in the installation area information storage 233. As shown in FIG. 7, the installation area information storage 233 stores, in association with each of the apparatus numbers “M001” to “M005” that correspond to the image forming apparatuses 6A to 6E, respectively, the area number indicating the area where each of the image forming apparatuses 6A to 6E is installed. For example, from the information stored in the installation area information storage 233, it is evident that the image forming apparatus 6A to which the apparatus number “M001” is allocated is installed in the area E1.

The communication device 24 is a communication interface including a communication module such as a LAN chip, and makes communication with external apparatuses. The information processing apparatus 2 is connected to the server 5 via the communication device 24, to transmit and receive data to and from the server 5. The information processing apparatus 2 also transmits and receive data to and from the image forming apparatus 6 via the server 5.

The control device 25 includes a processor, a RAM, a ROM, and a single-purpose hardware circuit. The processor is, for example, a CPU, an ASIC, or a MPU.

The control device 25 functions as a controller 251, an operation receiver 252, a personal authenticator 253, an area detector 254, and an area identifier 255, when the processor operates according to an operation control program stored in the storage device 23. However, the functions of the control device 25 may each be realized by a hardware circuit, instead of being realized by the operation of the control device 25 according to the operation control program. This also applies to other embodiments, unless otherwise specifically noted.

The controller 251 governs overall operation of the information processing apparatus 2. The controller 251 is connected to the operation device 21, the display device 22, the storage device 23, and the communication device 24. The controller 251 controls the operation of the mentioned components connected, as well as transmits and receives data and signals to and from those components.

The operation receiver 252 receives inputs made by the user through the operation device 21.

Upon receiving the ID number transmitted from the card reader 3, the personal authenticator 253 performs search on the ID number stored in the authentication data storage 231 to determine whether the ID number is permitted to enter the building 11 or to enter each of the areas E1 to E5.

When the personal authenticator 253 determines that the entry to the building 11 or the entry to the areas is permitted, the controller 251, in response to the determination result by the personal authenticator 253, transmits a lock-releasing notice to the corresponding electric lock 4. In receiving the lock-releasing notice from the information processing apparatus 2, the electric lock 4 unlocks the electric lock 4. Then, the controller 251 updates the staying location information stored in the staying location information storage 232, relevant to the ID number received by the personal authenticator 253.

On the basis of the staying location information stored in the staying location information storage 232 (i.e., detection information detected by the card reader 3), the controller 251 calculates the number of persons present in per area (i.e., each of the areas E1 to E5), and in accordance with the number of persons present in each of the areas E1 to E5, transmits from the communication device 24 via the server 5, the command notice for changing the state of the image forming apparatus 6 installed in each of the areas E1 to E5, to the respective image forming apparatuses. Specifically, the controller 251 changes the state of the image forming apparatus 6 installed in the area into a predetermined state where power consumption is more reduced, as the number of persons present in the area decreases. Upon receiving the command notice transmitted from the information processing apparatus 2, the image forming apparatus 6 changes the state of the image forming apparatus 6 in accordance with the command notice received.

Upon receiving via the communication device 24, the apparatus state information transmitted from the image forming apparatus 6, indicating the state where the power of the image forming apparatus 6 is turned on, on the basis of the staying location information stored in the staying location information storage 232 (i.e., detection information detected by the card reader 3), the area detector 254 detects the area where a person is present and detects the area detected as an area having possibility where the image forming apparatus 6 is being installed.

From results of one or more than two times of the detection by the area detector 254, the area identifier 255 narrows the area where the image forming apparatus 6 may be installed down to one area, and identifies the area where the image forming apparatus 6 is installed as the area that has narrowed down.

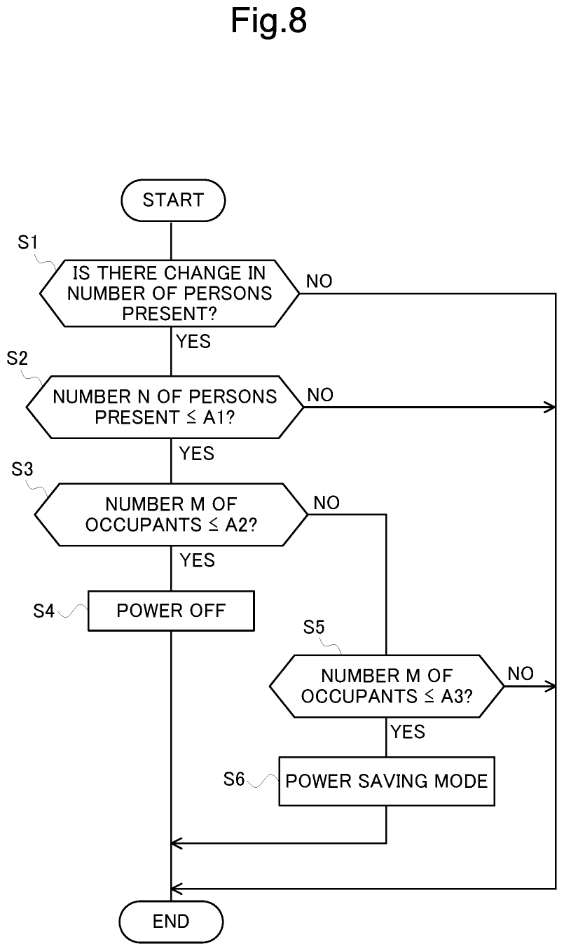

Next, descriptions will be given, with reference to a flowchart illustrated in FIG. 8, an example of the processing performed by the control device 25 of the information processing apparatus 2 according to the first embodiment. This processing is performed when the controller 251 updates the staying location information stored in the staying location information storage 232 (i.e., when user movement is detected).

Based on the updates of the staying location information stored in the staying location information storage 232, the controller 251 determines whether there was change in the number of persons present in any of the areas E where the image forming apparatus 6 is installed (here, the areas E1 to E3) (step S1).

Upon determination that there was change in the number of persons present in any of the areas E1 to E3 (YES in step S1), on the basis of the staying location information stored in the staying location information storage 232, the controller 251 calculates the number N of persons present in the area E where the change is detected, and determines whether the number N of persons present is a preset first threshold value A1 or lower (step S2).

In determining that the number N of persons present is the first threshold value A1 or lower (YES in step S2), on the basis of the staying location information stored in the staying location information storage 232, the controller 251 calculates the number M of occupants in the whole of the building, and determines whether the number M of occupants is a preset second threshold value A2 (>A1) or lower (step S3). The second threshold value A2 may be the same as the first threshold value A1, but it is preferable that the second threshold value A2 be increased by a predetermined small number (for example, two persons).

Upon determination that the number M of occupants is the second threshold value A2 or lower, in other words, when there are only few persons present in the area E and there are also few occupants in areas other than the area E (for example, in a case when only a someone like a guard is present) (YES in step S3), on the basis of the installation area information stored in the installation area information storage 233, the controller 251 transmits, via the server 5, to the image forming apparatus 6 installed in the area E, the command notice for causing the image forming apparatus 6 installed in the area E to be on the power-off state (step S4), and finishes the operation. The power-off state is a state of consuming very little power, and an example of the first power saving mode recited in What is claimed is.

As described above, when there are only few persons present in the area E where the image forming apparatus 6 is installed and there may be only a guard in the areas other than the area E and therefore it is estimated that the image forming apparatus 6 is very unlikely to be used, even if the image forming apparatus 6 is turned off, it is unlikely that user's convenience will be reduced.

In contrast, upon determination that the number M of occupants is not the second threshold value A2 or lower (NO in step S3), the controller 251 determines whether the number M of occupants is a preset third threshold value A3 (>A2) or lower (step S5).

Upon determination that the number M of occupants is the third threshold value A3 or lower, in other words, when there are only few persons present in the area E and there are not many but some occupants are in areas other than the area E (YES in step S5), on the basis of the installation area information stored in the installation area information storage 233, the controller 251 transmits, via the server 5, to the image forming apparatus 6 installed in the area E, the command notice for causing the image forming apparatus 6 installed in the area E to enter a power saving mode (step S6). Thereafter, the operation is finished. The power saving mode consumes more power than the power-off state, but consumes less power than a standby mode. The power saving mode is an example of the second power saving mode recited in What is claimed is.

When there are only few persons present in the area E where the image forming apparatus 6 is installed and there are not many but some occupants are in areas other than the area E, it is difficult for the controller 251 to determine that the occupants in areas other than the area E are unlikely to use the printer function of the image forming apparatus 6. Therefore, instead of turning off the power, the controller 251 causes the image forming apparatus 6 to enter the power saving mode.

In contrast, upon determination that the number M of occupants is not the third threshold value A3 or lower (NO in step S5), in other words, when there are only few persons present in the area E but there may be many occupants in areas other than the area E, because it is not desirable to turn off the power of the image forming apparatus 6 or to cause the image forming apparatus 6 to enter the power saving mode, the controller 251 finishes the operation.

Also, when the controller 251 determines in step S2 that the number N of persons present is not the first threshold value A1 or lower (NO in step S2) and when the controller 251 determines in step S1 that there is no change in the number of persons present in the areas E1 to E3 (NO in step S1), the operation finishes.

In the above-mentioned known first technique for suppressing power consumption, the image forming apparatus is required to have a detection unit. This leads to an increase in the cost of the image forming apparatus, and it is conceivable that the movement of a person cannot be properly detected due to an obstacle, and there is a possibility that the installation location of the image forming apparatus is limited. Furthermore, the above-mentioned known second technique controls the state of the image forming apparatus based on the information on the number of information processing devices. Therefore, although it can be controlled to a state suitable for a user for printing purposes, it cannot be controlled to a state suitable for a user who wants to use a copy function or a facsimile function.

The above-mentioned known third technique is suitable for the case of being used at a store or the like where the imaging device is installed originally. In offices where the imaging device is not commonly installed, a dedicated imaging device must newly be installed to detect the number of persons entering and exiting the area. Furthermore, the above-mentioned known fourth technique is considered to be relatively easy to use in the office. However, when the office is large and the image forming apparatus is installed in each of a plurality of areas, it is difficult to appropriately control the states of the image forming apparatuses based only on attendance information and usage frequency information within the office.

The entry and exit managing system of installing card readers at the entrances and exits of buildings, performing personal authentication using the IC cards or the like as keys, and managing and monitoring entering and exiting of each area in the building is introduced in many companies.

The presenter of the present application noticed that by utilizing the entry and exit information managed by the entry and exit management system, the number of persons present per area can be grasped without newly installing a detection device and on like the case of general technologies. Based on such idea, this disclosure was completed.

According to the first embodiment, as the number N of persons present in the area E decreases (i.e., the less likely it is to be used), the state of the image forming apparatus 6 installed in the area E is changed into a predetermined state where power consumption is more reduced. Therefore, the power saving of the image forming apparatus 6 can be accurately performed in accordance with the number of persons present. Furthermore, in the first embodiment, the state of the image forming apparatus 6 is controlled in consideration of not only the number N of persons present in the area E but also the number M of occupants in the whole of the building 11. This achieves more accurate power saving in accordance with the number of persons present.

In addition, because the card reader 3 that composes the entry and exit managing system 1A can be used as the entry and exit detecting device that detects entry and exit of the area E, a simple configuration is enough, and an increase in cost can be suppressed. Therefore, even when a plurality of image forming apparatuses 6 are installed in each different area E, it is possible to achieve appropriate power saving of the image forming apparatus 6 while suppressing the cost increase.

The entry and exit detecting device is not limited to the card reader 3: for example, (i) a finger vein reader for reading finger veins or (ii) a camera that shoots a face image may be used. In such case, the finger vein reader or the camera may transmit to the information processing apparatus 2 the obtained finger vein image or the obtained face image, and the controller 251 of the information processing apparatus 2 may determine whether the received finger vein image or the received face image matches with the finger vein image or the face image of a user stored in the storage device 23, and may read out the ID number stored in association with the finger vein image or the face image whose matching is determined.

The first embodiment refers to the case where the controller 251 causes the state of the image forming apparatus 6 to be changed into the predetermined state where power consumption is more reduced as the number N of persons present in the area E decreases. In another embodiment, the controller 251 may cause the state of the image forming apparatus 6 to be changed into a predetermined state where the power consumption is large as the number N of persons present in the area E increases. For example, when the number N of persons present in the area E becomes a preset number of persons or more, the controller 251 causes the image forming apparatus 6 installed in the area E to be entered from the power saving mode to the standby mode.

The first embodiment also refers to the case of changing the state of the image forming apparatus 6 installed in the area E in accordance with the number N of persons present in the area E where the change in the number of persons present is detected and the number M of occupants in the whole of the building. In still another embodiment, the controller 251 may calculate the number M2 of occupants in areas other than the area E where the change in the number of persons present is detected, and the controller 251 may cause the state of the image forming apparatus 6 installed in the area E to be changed in accordance with the number N of persons present and the number M2 of occupants.

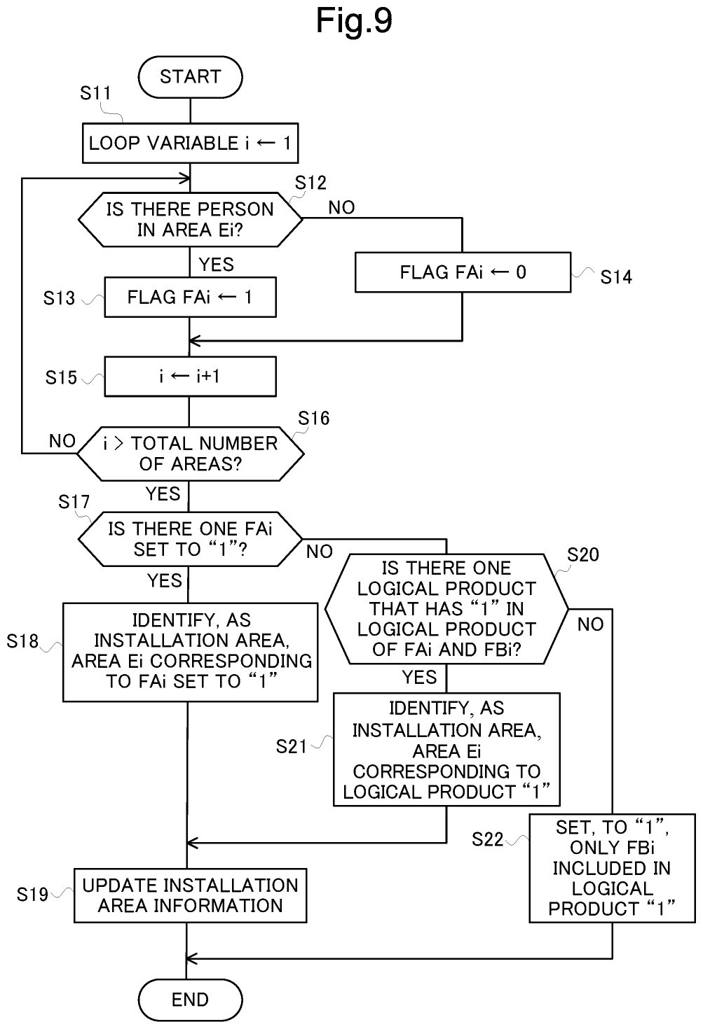

Hereunder, one example of registration of the installation area information into the installation area information storage 233 will be described with reference to a flowchart shown in FIG. 9. This processing is performed when the image forming apparatus 6 installed in the building 11 is turned on. The determination on whether the image forming apparatus 6 is on the power-on state is made by the controller 251 of the information processing apparatus 2 on the basis of the apparatus state information transmitted from the image forming apparatus 6. Here, an example in which the image forming apparatus 6A is turned on will be described.

When the controller 251 determines that the power of the image forming apparatus 6A is on, the area detector 254 sets a loop variable i to “1” (step S11) and, on the basis of the staying location information stored in the staying location information storage 232, determines whether there is a person present in an area Ei (step S12).

The fact that the image forming apparatus 6A is turned on always means that there is someone in the area E where the image forming apparatus 6A is installed. In other words, there is a possibility that the image forming apparatus 6A is being installed in the area where someone is present, but as for the area where no one is present, there is no possibility that the image forming apparatus 6A is being installed.

On the basis of the staying location information, upon determination that there is a person present in the area Ei (YES in step S12), the area detector 254 sets a flag FAi to “1” (step S13), the flag FAi indicating that the image forming apparatus 6A may be installed in the area Ei: upon determination that there is no person present in the area Ei (NO in step S12), the area detector 254 sets the flag FAi to “0” (step S14). Here, the flag FAi (i.e., flag FA1 to flag FA5) is prepared for each of the image forming apparatuses 6A to 6E.

Then, the area detector 254 increments the loop variable i (step S15) and determines whether the loop variable i is above a total number of areas (“5”, in this case) (step S16), and upon determination that the loop variable i is not above the total number of areas (NO in step S16), the processing returns to step S12.

When the area detector 254 determines that the loop variable i is above the total number of areas (YES in step S16), the area identifier 255 determines whether or not there is one flag FAi set to “1” (step S17).

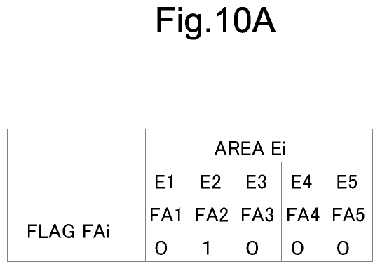

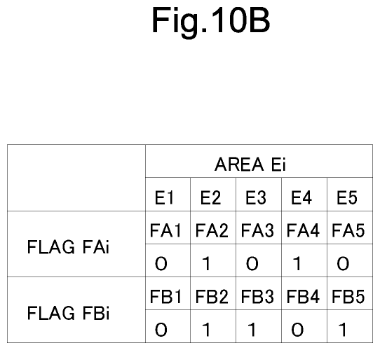

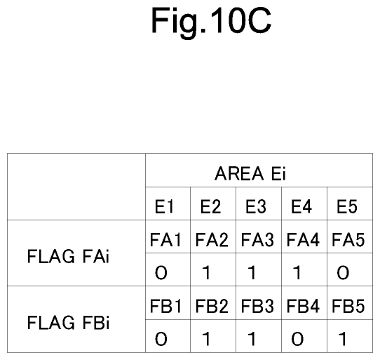

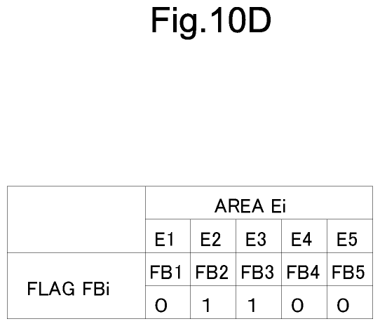

When it is determined that there is one flag FAi set to “1” (YES in step S17), it means that there is one area where the image forming apparatus 6A may be installed, the area identifier 255 identifies the area Ei corresponding to the flag FAi as the installation area of the image forming apparatus 6A (step S18). The controller 251 updates the installation area information stored in the installation area information storage 233 in accordance with the contents identified by the area identifier 255 (step S19), and finishes the operation. For example, when the flag FAi is set as shown in FIG. 10A, because only the flag FA2 is “1”, the area identifier 255 identifies that the area where the image forming apparatus 6A is installed as the area E2.

On the other hand, upon determination that the flag FAi set to “1” is not one (NO in step S17), the area identifier 255 determines whether or not there is one logical product that has “1” in the logical product of the flag FAi and a flag FBi (to be described later)(step S20). The flag FBi (i.e., FB1 to FB5) is a flag indicating the area Ei where the area detector 254 has determined before that there may be the image forming apparatus 6A installed.

The logical product of the flag FAi and the flag FBi is “1” when both of which are set to “1”: the logical product of the flag FAi and the flag FBi is “0” when one of which is set to “0”. Therefore, the area corresponding to the logical product that is not “1” is not to be the installation area of the image forming apparatus 6A.

When it is determined that there is one logical product that has “1” in the logical product of the flag FAi and a flag FBi (YES in step S20), the area where the image forming apparatus 6A may be installed can be narrowed down to one, so that the area identifier 255 identifies the area Ei corresponding to the flag FAi as the installation area of the image forming apparatus 6A (step S21). The controller 251 updates the installation area information stored in the installation area information storage 233 in accordance with the contents identified by the area identifier 255 (step S19). Thereafter, the operation is finished. For example, when the flag FAi and the flag FBi are set as shown in FIG. 10B, because only the logical product of the flag FA2 and the flag FB2 is “1”, the area identifier 255 identifies that the area where the image forming apparatus 6A is installed as the area E2.

On the other hand, when it is determined that there is not one logical product that has “1” in the logical product of the flag FAi and a flag FBi (NO in step S20), the area identifier 255 sets, to “1”, only the flag FBi having the logical product of the flag FAi and a flag FBi being “1”, and sets, to “0”, the rest of the flag FBi (step S22), and finishes the operation.

For example, when the flag FAi and the flag FBi are set as shown in FIG. 10C, the logical product of the flag FA2 and the flag FB2, and the logical product of a flag FA3 and a flag FB3 are “1”. Thus, as shown in FIG. 10D, the flag FB2 and the flag FB3 remains as “1” but the flag FB5 is changed into “0”.

As a result, the user work for registering the installation area information in the installation area information storage 233 can be omitted. In addition, when the image forming apparatus 6 is moved to another area, the installation area information stored in the installation area information storage 233 can be automatically updated.

In the foregoing first embodiment, descriptions were given with respect to the case where the information processing apparatus 2 performs the control of changing, in accordance with the number N of persons present in per area (i.e., each of the areas E), the state of the image forming apparatus 6 installed in the areas E. In the second embodiment, the server 5 may also include the staying location information storage 232 and the installation area information storage 233, like the information processing apparatus 2, to perform the same control.

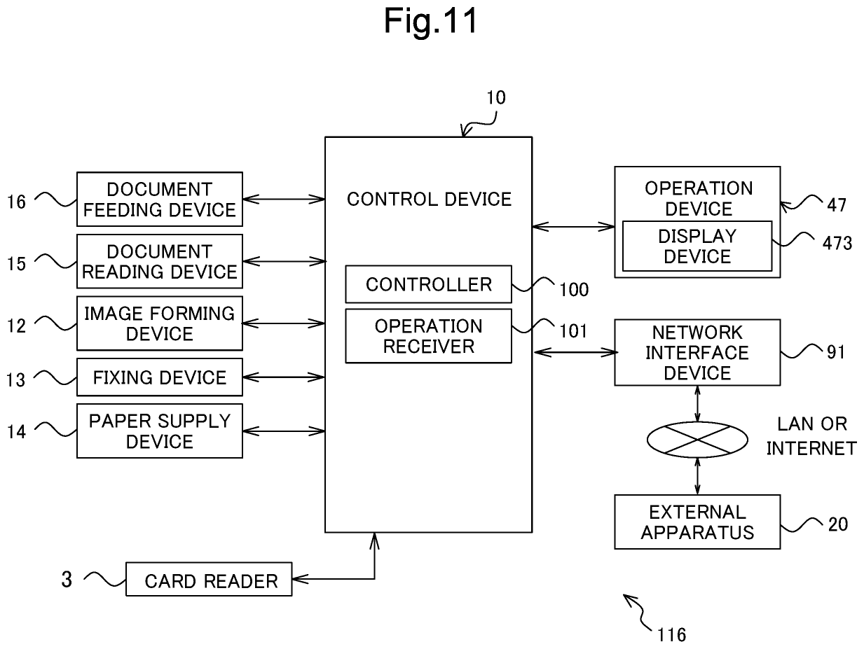

FIG. 11 is a functional block diagram schematically showing an essential internal configuration of the information processing apparatus according to the third embodiment. The image forming apparatus 116 according to the third embodiment is different from the image forming apparatus 6 shown in FIG. 3 in that the image forming apparatus 116 is connected to the card reader 3 being as the entry and exit detecting device. In addition, the image forming apparatus 116 is different from the image forming apparatus 6 shown in FIG. 3 in that not in accordance with the command notice transmitted from the information processing apparatus 2, but in accordance with the number of persons present in the area where the image forming apparatus 116 is installed, the image forming apparatus 116 itself changes the state of the image forming apparatus 116.

The card reader 3 is disposed in a doorway of the area where the image forming apparatus 116 is installed. The card reader 3 detects entry and exit of the area and transmits the entry and exit information to the image forming apparatus 116. Thereby, the image forming apparatus 116 grasps the number of persons present in the area where the image forming apparatus 116 is installed.

On the basis of the detection information detected by the card reader 3, the controller 100 calculates the number of persons present in the area where the own apparatus is installed, and changes, in accordance with the calculated number of persons present, the state of the own apparatus into a predetermined state where power consumption is more reduced, as the number of persons present in the area decreases. The image forming apparatus 116 may be configured to obtain the entry and exit information via the information processing apparatus 2, not obtain the entry and exit information directly from the card reader 3.

Still another embodiment, the image forming apparatus 116 may include the staying location information storage 232 and the installation area information storage 233, like the information processing apparatus 2, and may be configured to perform control of changing, not only the state of the own apparatus, but also the state of other image forming apparatus.

The disclosure is not limited to the foregoing embodiments, but may be modified in various manners. The configurations and arrangements according to the foregoing embodiment, described with reference to FIG. 1 to FIG. 11, are merely exemplary, and in no way intended to limit the disclosure to those configurations and arrangements.

While the present disclosure has been described in detail with reference to the embodiments thereof, it would be apparent to those skilled in the art the various changes and modifications may be made therein within the scope defined by the appended claims.

What is claimed is:

1. An information processing apparatus that manages an image forming apparatus installed in a building having a plurality of areas, the information processing apparatus comprising:
a storage device that stores installation area information indicating an area where the image forming apparatus is installed, of the plurality of areas;
a communication device that makes communication with an external apparatus; and
a control device that includes a processor and functions as a controller when the processor executes a control program, the controller, in accordance with the number of persons present per area obtainable based on detection information acquired by an entry and exit detecting device provided per area and detecting entering and exiting of the respective areas, determining, per area indicated by the installation area information, a state of the image forming apparatus installed in each area, and transmitting a command notice for changing the state of the image forming apparatus into the determined state, via the communication device, to the image forming apparatus installed in each of the areas,
wherein the controller transmits the command notice for changing the state of the image forming apparatus into a predetermined state where power consumption is more reduced, as the number of persons present in the area decreases.

2. The information processing apparatus according to claim 1, wherein
when the number of persons present in the area is a preset first threshold value or lower, the controller transmits the command notice for changing the state of the image forming apparatus installed in the area into a first power saving mode, via the communication device, to the image forming apparatus.

3. The information processing apparatus according to claim 1, wherein
in accordance with the number of persons present per area and the number of occupants in a whole of the building that are obtainable based on the detection information acquired by the entry and exit detecting device, the controller transmits the command notice for changing the state of the image forming apparatus into the predetermined state where power consumption is more reduced, as the number of persons present in the area and the number of occupants in the whole of the building decreases, via the communication device, to the image forming apparatus installed in each of the areas.

4. The information processing apparatus according to claim 3, wherein
when the number of persons present in the area is a preset first threshold value or lower and the number of occupants in the whole of the building is not more than a second threshold value previously set so as to be not less than the first threshold value, the controller transmits the command notice for changing the state of the image forming apparatus installed in the area into a first power saving mode, via the communication device, to the image forming apparatus, and
when the number of persons present in the area is the first threshold value or lower and the number of occupants in the whole of the building is above the second threshold value, the controller does not transmit the command notice for changing the state of the image forming apparatus installed in the area into the first power saving mode, via the communication device, to the image forming apparatus.

5. The information processing apparatus according to claim 4, wherein
when the number of persons present in the area is the first threshold value or lower, and the number of occupants in the whole of the building is above the second threshold value and also is not more than a third threshold value previously set so as to be greater than the second threshold value, the controller transmits the command notice for changing the state of the image forming apparatus installed in the area into a preset second power saving mode, via the communication device, to the image forming apparatus, the second power saving mode being a mode that consumes more power than the first power saving mode.

6. The information processing apparatus according to claim 1, wherein
the control device further functions as:
an area detector that, when the communication device receives apparatus state information indicating a power on state of the image forming apparatus and being transmitted from the image forming apparatus, detects an area where a person is present as an area having possibility that the image forming apparatus is installed, on a basis of the detection information acquired by the entry and exit detecting device; and
an area identifier that, on a basis of results of one or more than two times of the detection by the area detector, narrows the area having possibility that image forming apparatus is installed down to one, and identifies the area where the image forming apparatus is installed as the area that has narrowed down,
wherein the controller rewrites the installation area information stored in the storage device into the information indicating the area identified by the area identifier.

7. The information processing apparatus according to claim 4, wherein
when the number of persons present in the area is the first threshold value or lower and the number of occupants in the whole of the building is the second threshold value or lower, the controller transmits the command notice for changing the state of the image forming apparatus installed in the area into the first power saving mode, under which the image forming apparatus is on a power off state, via the communication device, to the image forming apparatus.

8. A control system comprising:
an entry and exit detecting device;
an information processing apparatus; and
a plurality of image forming apparatuses,
wherein the entry and exit detecting device detects entering and exiting per area, in a building having a plurality of areas,
wherein the information processing apparatus includes:
a storage device that stores installation area information indicating an area where an image forming apparatus is installed, of the plurality of areas;
a communication device that makes communication with an external apparatus; and
a control device that includes a processor and functions as a controller when the processor executes a control program, the controller, in accordance with the number of persons present per area obtainable based on detection information acquired by the entry and exit detecting device, determining, per area indicated by the installation area information, a state of the image forming apparatus installed in each area, and transmitting a command notice for changing the state of the image forming apparatus into the determined state, via the communication device, to the image forming apparatus installed in each of the areas,
wherein the controller transmits the command notice for changing the state of the image forming apparatus into a predetermined state where power consumption is more reduced, as the number of persons present in the area decreases and
wherein the image forming apparatus includes:
an image forming apparatus side controller that changes the state of the image forming apparatus in accordance with the command notice transmitted from the information processing apparatus; and
an image forming device that forms an image on a recording medium.

9. An image forming apparatus installed in a building having a plurality of areas,
the image forming apparatus comprising:
an image forming device that forms an image on a recording medium; and
a control device that includes a processor and functions as a controller when the processor executes a control program, the controller, in accordance with the number of persons present in an area, of the plurality of areas, obtainable based on detection information acquired by an entry and exit detecting device detecting entering and exiting of the area where the image forming apparatus is installed, changing a state of the image forming apparatus into a predetermined state where power consumption is more reduced, as the number of persons present in the area decreases.

10. An image forming apparatus comprising:
a storage device that stores installation area information indicating each area where the image forming apparatus is installed and each area where other image forming apparatus is installed, respectively;
a communication device that makes communication with an external apparatus;
a control device that includes a processor and functions as a controller when the processor executes a control program, the controller, in accordance with the number of persons present per area obtainable based on detection information acquired by an entry and exit detecting device provided per area and detecting entering and exiting of the respective areas, changing, per area indicated by the installation area information, a state of the image forming apparatus and a state of other image forming apparatus that are installed in the respective areas; and
an image forming device that forms an image on a recording medium,
wherein the controller determines the state of the image forming apparatus to be a preset first state where power consumption is more reduced, as the number of persons present in the area decreases, determines the state of other image forming apparatus to be a preset second state where power consumption is more reduced, as the number of persons present in the area decreases, and on a basis of the installation area information stored in the storage device, the controller changes the state of the image forming apparatus into the first state determined, and transmits a command notice for changing the state of the other image forming apparatus into the second state determined, via the communication device, to the other image forming apparatus.
